(19) United States
(12) Patent Application Publication
(10) Pub. No.: US 2023/0200360 A1
(43) Pub. Date: Jun. 29, 2023

(54) SYSTEM AND METHOD FOR CARBON SEQUESTRATION

(71) Applicant: YU-JIANG CHANG, TAICHUNG CITY (TW)

(72) Inventor: YU-JIANG CHANG, TAICHUNG CITY (TW)

(21) Appl. No.: 17/564,614

(22) Filed: Dec. 29, 2021

(51) Int. Cl. A01K 61/70; E21B 41/00

(52) U.S. Cl. CPC A01K 61/70; E21B 41/005

(57) ABSTRACT

A system and method for carbon sequestration is disclosed. The system comprises an artificial reef comprising a storage cavity for storing a content, the artificial reef is configured to be placed in a waterbody; and a blockchain based network or registry database for issuing a first amount of token to a first person when a corresponding unit of the content is stored in the artificial reef and placed in the waterbody, wherein the amount of token is tradeable between the first person and a second person via the blockchain based network or registry database.

### FIELD OF THE INVENTION

The present invention is related to a system for carbon sequestration; particularly, a system for storing carbon in ocean by utilizing artificial reef. The present invention further relates to an awarding mechanism for promoting carbon sequestration.

### BACKGROUND OF THE INVENTION

Carbon dioxide is the most commonly produced greenhouse gas. In order to reduce global warming, many methods had been developed to capture and store industry-emitted carbon dioxide in recent years. Particularly, carbon sequestration is the process of capturing and storing atmospheric carbon dioxide. In general, one of the most popular carbon sequestration methods involves the process of long-term storing the emitted carbon dioxide in underground geological formation (also known as geo-sequestration) as it enters the atmosphere. In geo-sequestration, supercritical form of carbon dioxide is usually injected into underground geological formations. Alternatively, it is suggested that carbon dioxide can be injected into saline formations, oil fields, gas fields . . . etc. Although the injection of CO₂ into geological formations or other storage mediums have been adapted for several decades, however, it is still a relatively expensive process. This is due to the fact that the technologies involving long-term storage security are difficult and uncertain. In addition to geo-sequestration, it had also been proposed to store carbon dioxide in the ocean. Due to the current international regulations and technical standards, many of the shallow ocean floor area cannot be used for carbon storage. Therefore, the present invention aims to provide a cost effective and secure method for deep ocean carbon storage.

### SUMMARY OF THE INVENTION

The present invention discloses a system for carbon sequestration capable of storing carbon dioxide in a waterbody. The system for carbon sequestration also involves a rewarding mechanism which is designed to give incentive or credit to those who store a certain amount of emitted carbon dioxide via the system for carbon sequestration of the present invention. Thereby, the present invention can greatly promote greenhouse gas sequestration and reduce global warming. The system for carbon sequestration, comprising an artificial reef for storing a carbon dioxide in a waterbody; and a blockchain based network or registry database for issuing a first amount of token to a first person when a corresponding unit of the carbon dioxide is stored in the waterbody. The token is tradeable between the first person and a second/the other person via the blockchain based network or registry database.

In some embodiments, the system for carbon sequestration may further comprise a video information generator for generating a video information of storing the carbon dioxide with the artificial reef in the waterbody. A second amount of token is issued to the first person when the video information is generated, the second amount of token is also tradeable between the first person and a third person via the blockchain based network or registry database.

In some embodiment, the artificial reef further comprises a storage cavity for storing a carbon dioxide therein; and a pressurizing mechanism, for maintaining an equilibrium between a pressure outside the artificial reef and a pressure inside the storage cavity.

In some embodiments, the artificial reef is operatable between a concealing status for storing the carbon dioxide or a discharging status for releasing the carbon dioxide into a surrounding. The artificial reef is operatable between the concealing status, or the discharging status based on a pressure difference between the pressure outside the artificial reef and the pressure inside the storage cavity.

In some embodiments, the artificial reef may have a substantially cubical shape consisting of pathways for marine living organism to navigate through or accommodated. It may comprise an opening in communication with the storage cavity for releasing the carbon dioxide into the surrounding. The carbon dioxide is in solid state or liquid state when the artificial reef is in the concealing status. The opening releases the carbon dioxide in the storage cavity when a pressure difference between the pressure inside the storage cavity and the pressure outside the artificial reef is larger than a threshold value. When the artificial reef is retrieving from the waterbody to a surface, the pressure outside the storage cavity is increasingly smaller than the pressure inside the storage cavity such that a pressure difference exceeds the threshold value, and the carbon dioxide is released via the opening.

### BRIEF DESCRIPTION OF THE DRAWINGS

FIG. 1 is a schematic illustrating carbon storage in accordance with the present invention.

FIG. 2 is a block diagram of the system for carbon sequestration in accordance with the present invention.

FIG. 3 is a schematic illustrating the artificial reef in accordance with the present invention.

FIG. 4 is another schematic illustrating the artificial reef in accordance with the present invention.

### DETAILED DESCRIPTION OF THE PREFERRED EMBODIMENTS

The terminology used in the description presented below is intended to be interpreted in its broadest reasonable manner, even though it is used in conjunction with a detailed description of certain specific embodiments of the technology. Certain terms may even be emphasized below; however, any terminology intended to be interpreted in any restricted manner will be specifically defined as such in this Detailed Description section. Embodiments of the present invention will be described, by way of examples only, with reference to the accompanying drawings.

Artificial reefs 100 are human-created underwater structures for promoting marine life in a particular area. They are typically placed on seabed and have strong capability of resisting erosion occurrence. In many instances, artificial reefs 100 are built using materials or objects that were previously constructed for other purposes, such as shipwrecks or old oil rigs. In other instances, artificial reefs 100 may be built with concrete or polyvinyl chloride or the like. Artificial reefs 100 generally provide hideaway for marine lives; or it may provide surfaces on which algae and invertebrates can attach to, thereby promoting marine ecosystem.

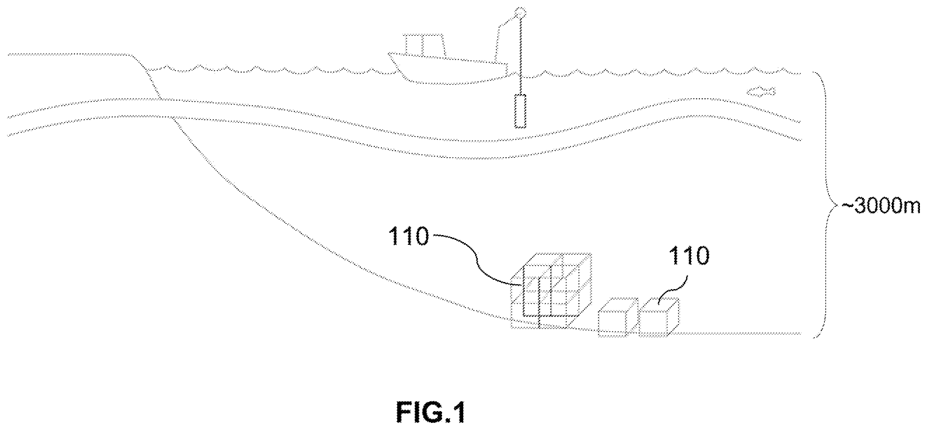

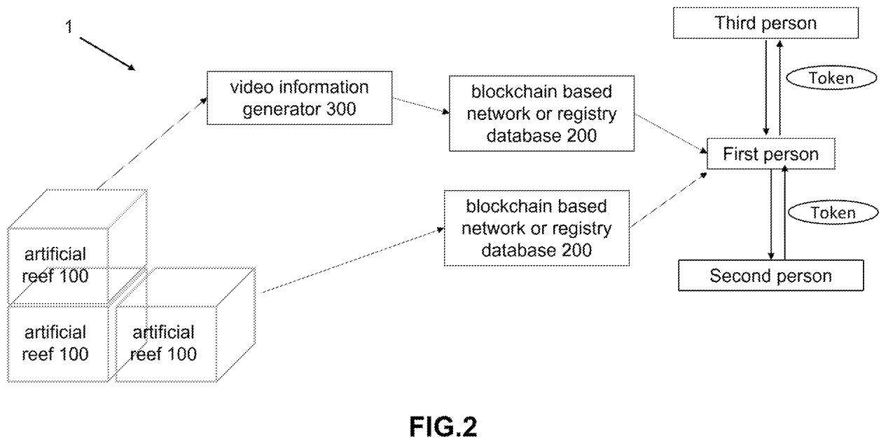

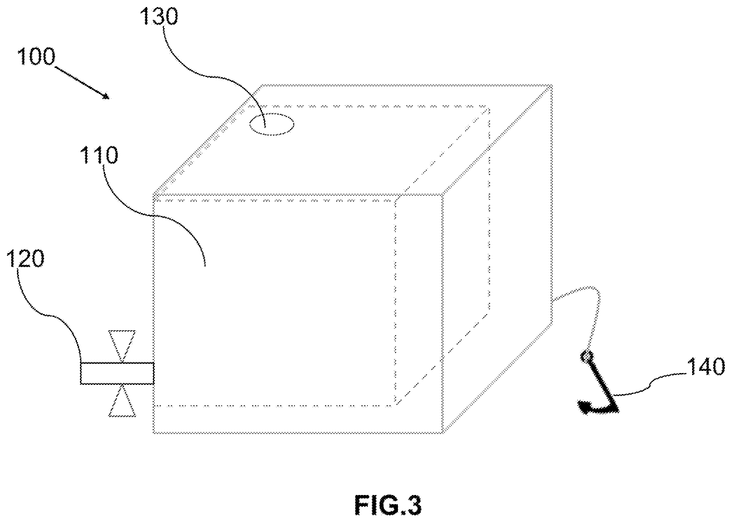

With reference to FIGS. 1, 2, and 3, the carbon sequestration system 1 in accordance with the present invention does not only promote marine ecosystem, but it also provides greenhouse gas storage (such as carbon dioxide) capability which is further beneficial to the environment. The carbon sequestration system 1 comprises an artificial reef 100 for storing a content in a waterbody, and a blockchain based network or registry database 200 for issuing a first amount of token to a first person when a corresponding unit of the content is stored in the waterbody by using the artificial reef 100. The content mentioned herein may be greenhouse gases such as carbon dioxide; however, other types of greenhouse gases may also be stored with the present invention. The artificial reef 100 may be a partially hollow structure comprising a storage cavity 110 for storing the content therein. As an example, the artificial reef 100 may be made of high-density polyethylene (HDPE) and may have a dimension of 1 m³. However, the artificial reef 100 may be made of other plastic materials or the like and have a variety of dimensions. The exterior of the artificial reef 100 may have similar functions to those of the artificial reefs 100 in the current art. The artificial reef 100 may comprise a pressurizing mechanism 120 for controlling the internal pressure within the storage cavity 110; and/or the pressurizing mechanism 120 may be used to regulate or balance the pressure between the storage cavity 110 and the exterior of the artificial reef 100 for maintaining an equilibrium between the pressure outside the artificial reef 100 and a pressure inside the storage cavity 110. The pressurizing mechanism 120 is in communication with the storage cavity 110.

As mentioned earlier, the content mentioned herein may be greenhouse gasses such as carbon dioxide, or any other forms of carbon dioxide related materials. In some embodiments, the content may be materials in gaseous, liquid, or solid form depending on the internal pressure within the cavity. The artificial reef 100 is placed within a waterbody for storing the content. As an example, for placing a large number of artificial reefs 100, the artificial reefs 100 may be place on seabed and may be stacked on top of each other, as shown in FIG. 1.

In some embodiment, the pressure of the water outside the artificial reefs 100 can affect the phase (gaseous phase, liquid phase or solid state) of the content. Therefore, the phase of the content stored within the storage cavity 110 can be manipulated or maintained by varying the pressure equilibrium between the outside the artificial reef 100 and the storage capacity via the pressurizing mechanism 120. This can be achieved by varying the storing depth within the water body of the artificial reef 100, and then allow the water to flow in or out from the storage cavity 110 via the pressurizing mechanism 120. For example, placing the artificial reef 100 in deep ocean can create higher pressure than placing the artificial reefs 100 in shallow water. When it is desirable to store carbon dioxide in solid or liquid form, the corresponding temperature and pressure may be determined based on the phase diagram of carbon dioxide.

The depth of storage can then be determined according to the pressure and temperature required for carbon dioxide to be in a specific phase. In general, in order to maintain carbon dioxide in solid form, the depth of storage is typically close to 3000 m. In many instances, it is desirable to store the content in its liquid or solid for because it requires much less storing space relative to the gaseous form. If the phase of the content needs to be changed, the depth of the storage can be regulated or manipulated to change the water pressure outside the artificial reef 100. In this embodiment, the pressurizing mechanism 120 may be used to regulate the pressure within the storage cavity 110 or to balance the pressure between the storage cavity 110 and the exterior of the artificial reef 100 for maintaining an equilibrium therebetween. For example, when the pressure within the storage cavity 110 is smaller than the pressure outside the artificial reef 100 (e.g., the storage depth is increased), sea water may flow into the storage cavity 110 via the pressurizing mechanism 120 to increase the pressure within the storage cavity 110; as a result the content may experience a higher pressure. On the other hand, when the pressure within the storage cavity 110 is larger than the pressure outside the artificial reef 100 (e.g., the storage depth is decreased), the content or the sea water within the storage cavity 110 may be dispensed through the pressurizing mechanism 120 to reduce the pressure inside the storage cavity 110. Evidently, the pressure within the storage cavity 110 may be regulated or maintained to be approximately the same as the exterior pressure created by the water pressure. By placing the artificial reef 100 in deep ocean, the content can be easily maintained at its desirable state (e.g., solid state) without any additional required pressurizing system, which is simple and cost effective.

In another embodiment of the present invention, when used as a storage for the content, the artificial reef 100 is in a concealing status. However, the artificial reef 100 can be in a discharging status for releasing the content into the surrounding as well. The concealing status and the discharging status may be related to the pressure difference between the pressure outside the artificial reef 100 and the pressure inside the storage cavity 110, as mentioned previously. For examples, in one embodiment, when the pressure inside the storage cavity 110 is smaller than or equal to the pressure outside the artificial reef 100, the artificial reef 100 is in a concealing status; when the pressure inside the storage cavity 110 is larger than the pressure outside the artificial reef 100, the artificial reef 100 is in the discharging status. In another embodiment, when the pressure difference between the storage cavity 110 and the exterior is smaller than a value or equal to zero, the artificial reef 100 is in a concealing status; when the pressure difference between the storage cavity 110 and the exterior is larger than a value (generally speaking, the pressure within the storage cavity 110 is larger than the pressure outside the artificial reef 100), the artificial reef 100 is in a discharging status. During the discharging status, since the pressure is greater inside the storage cavity 110 than outside, the content is discharged from the artificial reef 100. In other words, the artificial reef 100 is operatable between the concealing status or the discharging status based on a pressure difference between the pressure outside the artificial reef 100 and the pressure inside the storage cavity 110. As mentioned, the pressure outside the artificial reef 100 is related to a water pressure, the water pressure is varied via changing a depth of the artificial reef 100 relative to the waterbody.

In one embodiment of the present invention, the content may be discharged via an opening 130 of the artificial reef 100. The opening 130 is in communication with the storage cavity 110. The opening 130 may be configured to be sealed during normal condition and opened when the pressure inside the storage cavity 110 is greater than the pressure outside the artificial reef 100 and the pressure difference therebetween is larger than a threshold value. In one specific example, the artificial reef 100 may be filled with carbon dioxide and store on the seabed. The pressurizing mechanism 120 in the present embodiment may be a non-return valve. The non-return valve allows the pressure of the storage cavity 110 to build up when the temperature rises or the pressure outside the artificial reef 100 decreases to cause the solid or liquid form of the content to evaporate or sublimate in the storage cavity 110. In some instances, the artificial reef 100 may be retrieved from the seabed to the surface of the ocean to release the carbon dioxide within the storage cavity 110. When the artificial reef 100 travels from the seabed to the surface of the ocean, the pressure outside the storage cavity 110 is increasingly smaller and the temperature also increases; this causes the solid or liquid form of carbon dioxide to evaporate or sublimate and turn into partially gaseous phase, which may increase the pressure within the storage cavity 110. The pressure inside the storage cavity 110 is increasingly larger than the outside pressure such that the pressure difference exceeds the threshold value. In this embodiment, the opening 130 is configured to release the content only when the pressure difference exceeds the threshold value. The pressurized mechanism in this embodiment only allows pressure inside the storage cavity 110 to increase. In other words, the pressurized mechanism only allows sea water to flow into the storage cavity 110.

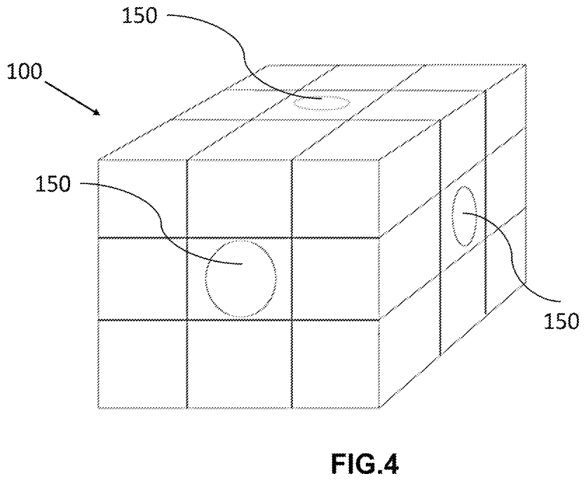

With reference to FIG. 4, the shape of the artificial reef 100 in accordance with the present invention may have a substantially cubical shape. In this configuration, it may be easier for a plurality of the artificial reefs 100 to be stacked on top of each other. However, the artificial reef 100 does not need to be limited to have cubical shape. In some other embodiments, it may be, for examples, a rectangular column or irregular shaped. The artificial reef 100 may comprise a pathway 150 for marine living organism to navigate through the artificial reef 100; or the artificial reef 100 may comprise pathways 150 for marine animals to hide inside.

The content within the artificial reef 100 may be inputted into the storage cavity 110 prior to placing the artificial reef 100 on the seabed. As an example, the solid or liquid form of the carbon dioxide may be loaded to the artificial reef 100 and sealed within the artificial reef 100 prior to being placed on the seabed. Once the artificial reef 100 is drop into the ocean, the pressure outside the artificial reef 100 quickly increases while the temperature decreases, which help maintaining carbon dioxide in the storage cavity 110 in the desired liquid or solid form without the requirement of any additional pressuring devices. Apparently, the method and system for storing carbon dioxide in accordance with the present invention is environmentally friendly.

In one embodiment of the present invention, in order to prevent the artificial reef 100 from carried away by the ocean current, the artificial reef 100 may further comprise an anchor 140 attached to the artificial reef 100 for maintaining a position of the artificial reef 100 on seabed. Each artificial reef 100 may be attached to at least one anchor 140; however, in multiple artificial reefs 100 may be attached to a single anchor 140 in some instances.

In one embodiment of the present invention, in order to promote carbon sequestration, the system and method for carbon sequestration may comprise a blockchain based network or registry database 200 for issuing a first amount of token to a first person when a corresponding unit of the content is stored in the waterbody. The first person may be a person or company storing a specific amount of carbon dioxide via the artificial reef 100 provided by the present invention. As an example, once the first person is rewarded with the first amount of token, the token may represent a certain right for future carbon emission. The first person can trade the first amount of token on a secondary market with a second person on the secondary market via the blockchain based network or registry database 200. The blockchain based network or registry database 200 ensure the security and integrity of the token so it cannot be manipulated or forged. With this approach, carbon sequestration is promoted and while carbon emission allowance is also limited.

In another embodiment of the present invention, the system and method for carbon sequestration may further comprise a video information generator 300 for generating a video information of storing the content with the artificial reef 100 in the waterbody. More specifically, the video information generator 300 may be a camera for capturing the video of storing the content with the artificial reef 100 in the waterbody. The video itself may be valuable for the first person who store a certain amount of carbon dioxide via the system and method for carbon sequestration of the present invention. Furthermore, a second amount/class of token may be issued to the first person when the video information is generated, the second amount/class of token is also tradeable between the first person and another person (e.g., third person) via the blockchain based network or registry database 200 on another secondary market.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A system for carbon sequestration, comprising:
an artificial reef comprising a storage cavity for storing a content, the artificial reef is configured to be placed in a waterbody; and
a blockchain based network or registry database for issuing a first amount of token to a first person when a corresponding unit of the content is stored in the artificial reef and placed in the waterbody,
wherein the amount of token is tradeable between the first person and a second person via the blockchain based network or registry database.

2. The system of claim 1, further comprising a video information generator for generating a video information of storing the content with the artificial reef in the waterbody.

3. The system of claim 2, wherein a second amount of token is issued to the first person when the video information is generated, the second amount of token is tradeable between the first person and a third person via the blockchain based network or registry database.

4. The system of claim 1, wherein the artificial reef further comprises:
a pressurizing mechanism, in communication with the storage cavity for regulating a pressure inside the storage cavity.

5. The system of claim 1, wherein the artificial reef is operatable between a concealing status for storing the content or a discharging status for releasing the content into a surrounding.

6. The system of claim 1, wherein a phase of the content is manipulated or maintained by varying a pressure outside the artificial reef by changing a depth of the artificial reef relative to the waterbody.

7. The system of claim 5, wherein the artificial reef is operatable between the concealing status or the discharging status based on a pressure difference between a pressure outside the artificial reef and a pressure inside the storage cavity.

8. The system of claim 4, wherein the pressurizing mechanism maintains an equilibrium between the pressure outside the artificial reef and the pressure inside the storage cavity.

9. The system of claim 1, further comprising an anchor attached to the artificial reef for maintaining a position of the artificial reef on seabed.

10. The system of claim 5, wherein the content is in solid state or liquid state when the artificial reef is in the concealing status.

11. The system of claim 1, wherein the artificial reef has a substantially cubical shape.

12. The system of claim 1, further comprising a pathway for marine living organism to navigate through the artificial reef.

13. The system of claim 1, further comprising a pressurizing mechanism is a non-return valve.

14. The system of claim 1, further comprising an opening in communication with the storage cavity for releasing the content into the surrounding.

15. The system of claim 13, wherein the opening releases the content in the storage cavity when a pressure difference between a pressure inside the storage cavity and a pressure outside the artificial reef is larger than a threshold value.

16. The system of claim 15, wherein when the artificial reef is retrieving from the waterbody to a surface, the pressure difference exceeds the threshold value and the content is released via the opening.

17. An artificial reef, comprising:
a storage cavity for storing a content, the artificial reef is configured to be placed in a waterbody;
a non-return valve, in communication with the storage cavity for regulating a pressure inside the storage cavity; and
an opening in communication with the storage cavity for releasing the content into the surrounding,
wherein the content is in solid state or liquid state when the artificial reef is in the concealing status.

18. The artificial reef of claim 17, wherein the artificial reef is operatable between a concealing status or a discharging status based on a pressure difference between a pressure outside the artificial reef and a pressure inside the storage cavity.

19. The artificial reef of claim 17, wherein the opening releases the content in the storage cavity when a pressure difference between a pressure inside the storage cavity and a pressure outside the artificial reef is larger than a threshold value, when the artificial reef is retrieving from the waterbody to a surface, the pressure difference exceeds the threshold value and the content is released via the opening.

20. The artificial reef of claim 17, further comprising a pathway for marine living organism to navigate through the artificial reef.
